(19) United States
(12) Patent Application Publication
(10) Pub. No.: US 2008/0062995 A1
(43) Pub. Date: Mar. 13, 2008

(54) System and Method for Identifying and Forwarding a Data Sequence of a Communications Network

(75) Inventors: Gerard Edmond Kaas, Verneuil / Se Ine (FR); Benjamin Calais, Dallas, TX (US)

Correspondence Address: L. HOWARD CHEN;KIRKPATRICK & LOCKHART PRESTON GATES ELLIS, LLP, 55 SECOND STREET, # 1700, SAN FRANCISCO, CA, 94105, US

(73) Assignee: CheckPhone, Inc.

(21) Appl. No.: 11/938,166

(22) Filed: Nov. 9, 2007

(30) Foreign Application Priority Data
Sep. 6, 2005 (FR) 05/52691

(51) Int. Cl. H04L 12/56

(52) U.S. Cl. 370/392; 370/401

(57) ABSTRACT

A system identifies and forwards a first and a second data sequence to a communications network based on Quality of Service (QoS) requirements. The system includes a protocol database for storing a protocol, a proxy module for analyzing first Open Systems Interconnection (OSI) headers of the first data sequence based on the protocol. The first OSI headers includes headers of layers 5 through 7, a connection database for storing connectivity information about the second data sequence obtained from the content of the first data sequence by the proxy module, and an ID tagger for analyzing second OSI headers and tagging a unique ID to the first and the second data sequences. The second OSI headers include headers of layers 3 through 4. The first and the second data sequences are forwarded to the communications network configured to support QoS requirements of the first and the second data sequences.

### CROSS REFERENCE

The present application claims the benefit of French Application FR-05/52691 which was filed Sep. 6, 2005. The content of the French application is herein incorporated by reference in its entirety and a copy of the English translation of the French application is filed herewith.

### BACKGROUND

The network of a communications service provider generally comprises a data network supporting traditional data applications and a voice data network (voice network henceforth) supporting voice-over-IP (VOIP) applications. Quality of Service (QoS) provided by a communications network refers to a mechanism for reserving and controlling network resources. QoS provides different priorities to different users or flows of data sequences. Therefore, a flow of data is guaranteed to receive certain level of service in accordance with requests from the application program or the Internet service provider policy.

The requirements of QoS for a data network are very different from those for a voice network. Generally speaking, a data network serves applications that require high bandwidth and high throughput while a voice network serves applications that require low delay and low jitter. In order to support voice and data networks, a communications network service provider either constructs two physically separated networks or partitions a physical network into logically separated networks, which are often referred to as virtual networks. A virtual network can be configured as a data network or a voice network. Partitioning a network into virtual networks is a commonly used approach.

An application must be served by a corresponding virtual network which provides required QoS. A data sequence (a.k.a. data packet) is tagged with a unique ID associated with the communications network which it enters. The management function of the communications network forwards the tagged data sequence to a corresponding virtual network supporting the required QoS.

Customers of communications service providers typically install separate devices for VOIP and data applications. Before entering a communications network, a data sequence originating from a device is tagged with a unique ID that reflects the type of device. There are a number of ways to tag a data sequence, such as port-based tagging, device-based tagging, and network card-based tagging.

Port-based tagging starts with configuring a network switch. A port corresponding to a specific application type is assigned a unique ID. When a device is connected to a port on the network switch, any data sequence entering the port is tagged with the unique ID associated with the application type. Port-based tagging is not ideal in that it only supports one ID per port. In addition, it requires an external switch and thus increases operating costs.

As to device-based tagging, it requires configuring a device into a virtual network tagging node. The tagging of a unique ID is performed at the device driver layer. Like port-based tagging, device-based tagging only supports one unique ID per device. Moreover, it fails to associate dynamically allocated communications ports with a unique ID.

Unlike the two types of tagging described above, network card based-tagging requires that a network card be installed in a device in order to tag a data sequence with a unique ID. For example, a network card can perform VLAN encapsulation according to standard IEEE 802.3 specification. A network card with limited processing capability can only support tagging based on layer 2 or layer 3 information. It has no capacity to look at the upper layer protocol to determine the assignment of a unique ID. Like the other two types of tagging, network card based-tagging also incurs high operating costs.

To reduce operating costs, customers of communications service providers choose to install devices (e.g., softphones) that support both data and VOIP applications. Typically, a softphone is a computer with an integrated VOIP function. To further reduce the costs incurred by the tagging methods described above, a softphone with a single network card employs functions to identify and tag a data sequence with an ID corresponding to the application type.

Embodiments of the present invention provide a system and method for identifying and tagging a data sequence with a unique ID corresponding to an application type.

### SUMMARY

The present invention discloses a system and method for identifying and forwarding a first and a second data sequence to a communications network in accordance with Quality of Service (QoS) requirements. The system comprises of a protocol database for storing a predetermined protocol, a proxy module for analyzing a first plurality of Open Systems Interconnection (OSI) headers of the first data sequence based on the predetermined protocol to identify an application type, wherein the first plurality of OSI headers comprises headers of layers 5 to 7, a connection database for storing connectivity information about the second data sequence, which is obtained from the content of the first data sequence by the proxy module, and an ID tagger for analyzing a second plurality of OSI headers and tagging a unique ID to the first and the second data sequences, wherein the second plurality of OSI headers comprises headers of layers 3 and 4, wherein the first and the second data sequences are forwarded to the communications network configured to support Quality of Service (QoS) requirements of the first and the second data sequences.

The construction and method of operation of the invention, however, together with additional objects and advantages thereof, will be best understood from the following description of specific embodiments when read in connection with the accompanying drawings.

### BRIEF DESCRIPTION OF THE DRAWING

The drawings accompanying and forming part of this specification are included to depict certain aspects of the invention. The invention may be better understood by reference to one or more of these drawings in combination with the description presented herein. It should be noted that the features illustrated in the drawings are not necessarily drawn to scale.

FIG. 1 is a system architecture comprising a communications service provider network and a communications device in accordance with one embodiment of the present invention.

FIG. 2 is a flow diagram illustrating the method disclosed in the present invention.

FIG. 3 is a communications device in accordance with one embodiment of the present invention.

### DESCRIPTION

The following detailed description of the invention refers to the accompanying drawings. The description includes exemplary embodiments, not excluding other embodiments, and changes may be made to the embodiments described without departing from the spirit and scope of the invention. The following detailed description does not limit the invention. Instead, the scope of the invention is defined by the appended claims.

The present invention discloses a method and system for tagging a data sequence, originating from/terminating at a communications device that supports both voice and data applications, with a unique ID according to Quality of Service (QoS) requirements. In this method, headers of layers 3 to 7 of a data sequence are examined, and a unique ID is subsequently attached to the data sequence according to a predetermined rule set up by a communications network service provider. In addition, a communications network service provider creates a plurality of logical data networks, also known as virtual networks. Each of the virtual networks is associated with a unique ID, and it is configured according to the QoS requirements of the corresponding applications.

Virtual networks are stored in one physical data network, and they are configured according to QoS requirements of the corresponding applications. A tagged data sequence is forwarded to a corresponding virtual data network. In one embodiment of the present invention, a unique ID is a virtual local area network (VLAN) ID, defined by the IEEE 802.3 standard. A data sequence carrying a VLAN tag is forwarded to a corresponding virtual network, and it traverses through the virtual network until it reaches its destination.

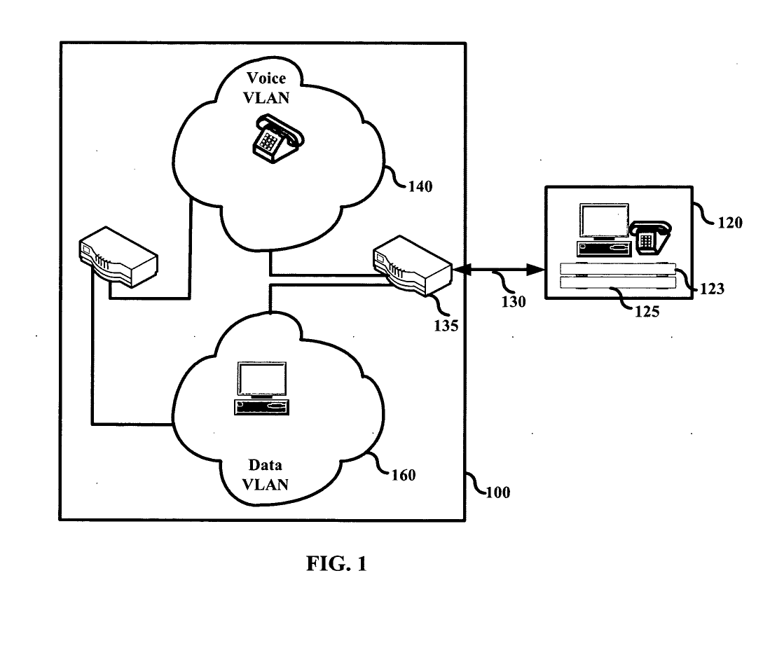

FIG. 1 is a system architecture comprising a communications service provider network and a communications device in accordance with one embodiment of the present invention. A communications service provider network 100 comprises a voice VLAN 140 and a data VLAN 160. A communications devices 120 supports both voice and data applications.

The communications device 120 is connected to two VLANs via a VLAN-enabled switch 135. A proxy module 123 and a tagger module 125 are embedded in the communications device 120. The proxy module 123 and the tagger module 125 are either a software or hardware module. Through the proxy module 123 and the tagger module 125, the communications device 120 is connected to a voice VLAN 140 and a data VLAN 160 using a single network interface 130 via a network switch 135.

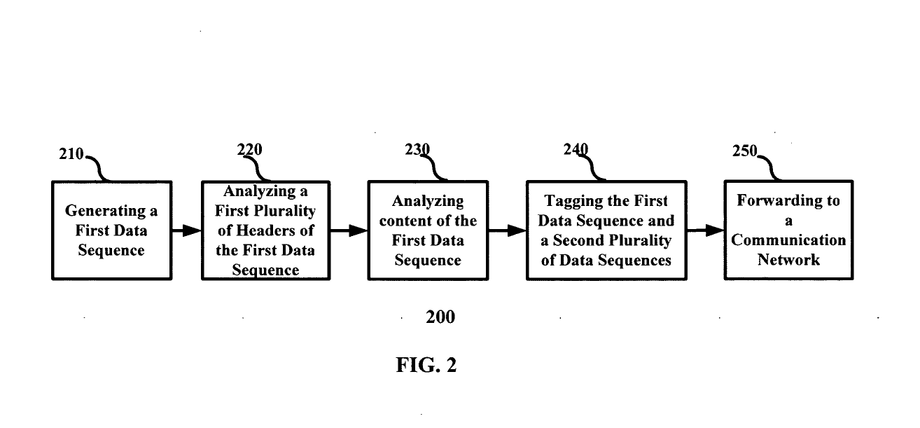

FIG. 2 is a flow diagram illustrating the method disclosed in the present invention. A first data sequence is generated by an application (step 210). A proxy module identifies the type of application that generates the first data sequence by examining the protocol headers embedded in the first data sequence (step 220). The protocol headers comprise headers of layers 5 to 7 in accordance with Open Systems Interconnection (OSI) specification. The proxy module consults a protocol database that contains information about headers of all well-known protocols and some predetermined proprietary protocols.

In step 230, the proxy module analyzes the content embedded in the first data sequence according to the protocol identified in step 220. Afterwards, the proxy module obtains connection information including dynamically allocated communications ports of a network connection and subsequently records the information in a connection database.

An ID tagger module decodes headers of OSI layers 3 and 4, and tags the first data sequence, identified in step 220, with an ID specified in the protocol database (step 240). Using information in the connection database, the ID tagger module also tags a second data sequence that passes through the dynamically allocated communications ports, obtained in step 230, with an ID. The second data sequence is associated with the first data sequence. Tagging is performed in layer 2, defined by the OSI. The tagged data sequence is sent to a communications network (step 250).

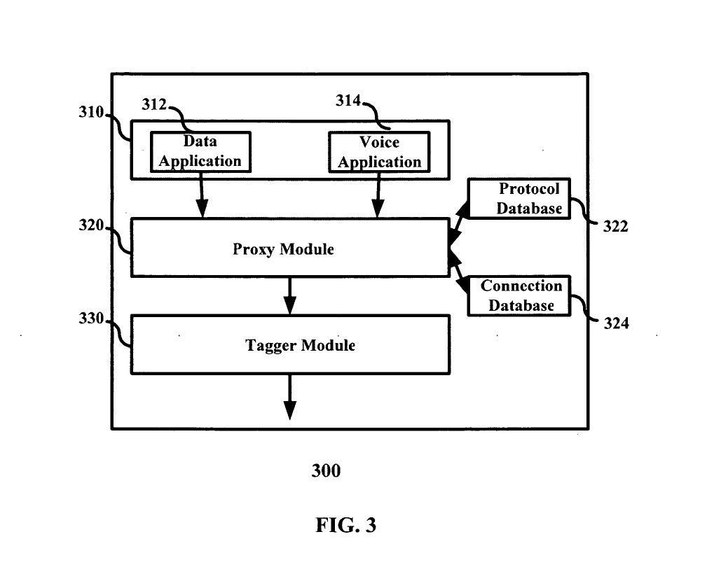

FIG. 3 is a communications device in accordance with one embodiment of the present invention. A communications device 300 comprises an application module 310, a proxy module 320, a protocol database 322, a connection database 324, and an ID tagger module 330. The application module 310 holds data applications 312 and voice data applications 314. The proxy module 320 analyzes data sequences originating from the application module 310 without modifying the data sequences.

The ID tagger module 330 works in collaboration with the proxy module 320. The ID tagger module 330 tags a first data sequence carrying a predetermined protocol, defined in the protocol database 322, and a second data sequence, associated with the first data sequence, with the unique ID specified in the protocol database 322. The second data sequence is destined to communications ports that are recorded in the connection database 324. The proxy module 320 retrieves the information about the communications ports from the content of the first data sequence.

An exemplary scenario is described below. For a voice application, the known protocols pertinent to VOIP operation include SIP, MGCP, H323, Megaco, etc. Every protocol pertinent to VOIP operation, along with an ID, is stored in the protocol database 322. For example, a VLAN ID is set to 1 for all the above protocols.

The application module 310 forwards data sequences, generated by the voice application, to the proxy module 320. Data sequences carrying the SIP protocol are destined to a communications port (Port 5600). After identifying the data sequence carrying the SIP protocol, the proxy module 320 examines connection information (i.e. the port number) carried in the data sequence.

The proxy module 320 looks for call signal messages in the data sequence carrying the SIP protocol. It also looks for information about the type of voice codec and communications ports. The information about the communications ports associated with a voice session is recorded in the connection database 324.

The ID tagger module 330 receives the data sequence from the proxy module and tags the data sequence with the ID specified in the protocol database 322. Tagging is performed in OSI layer 2. In one embodiment, an ID tag is a VLAN tag and the ID tagger module updates the VLAN ID field of the data sequence, defined by the IEEE 802.3 specification. For example, all data sequences carrying SIP messages, such as INVITE, ACK, BYE, CANCEL, REFER, and SDP, are tagged with an VLAN ID, which is set to 1. The data sequences passing through the communications ports are also tagged with a VLAN ID.

In the system architecture of the communications device, the ID tagger module 330 resides below the device driver of a communications device. By positioning the ID tagger module 330 below the device driver, the ID tagger module 330 can work with any network card without having to modify the device driver.

When the proxy module 320 detects that a voice session is terminated, it removes the communications ports associated with the voice session from the connection database 324. The termination of the voice session is determined by the SIP data sequence carrying messages such as BYE and CANCEL.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A system for identifying and forwarding a first and a second data sequence to a communications network in accordance with Quality of Service (QoS) requirements, the system comprising:
a protocol database for storing a predetermined protocol;
a proxy module for analyzing a first plurality of Open Systems Interconnection (OSI) headers of the first data sequence based on the predetermined protocol to identify an application type, wherein the first plurality of OSI headers comprises headers of layers 5 to 7;
a connection database for storing connectivity information about the second data sequence, which is obtained from the content of the first data sequence by the proxy module; and
an ID tagger for analyzing a second plurality of OSI headers and tagging a unique ID to the first and the second data sequences, wherein the second plurality of OSI headers comprises headers of layers 3 and 4,
wherein the first and the second data sequences are forwarded to the communications network configured to support Quality of Service (QoS) requirements of the first and the second data sequences.

2. The system of claim 1, wherein the predetermined protocol is a proprietary protocol.

3. The system of claim 2, wherein the predetermined protocol is a Session Initiation Protocol (SIP).

4. The system of claim 1, wherein the connectivity information includes types of voice codec.

5. The system of claim 1, wherein the connectivity information includes communications ports.

6. The system of claim 5, wherein the second data sequence passes through the communications ports specified in the content of the first data sequence.

7. The system of claim 1, wherein the unique ID is a VLAN ID defined by IEEE 802.3 specification.

8. The system of claim 1, wherein the ID tagger tags the first data sequence carrying the predetermined protocol with the VLAN ID.

9. The system of claim 1, wherein the ID tagger tags the second data sequence with the VLAN ID.

10. The system of claim 11, wherein the ID tagger tags the VLAN ID at OSI layer 2 header.

11. A method for identifying and forwarding a first and a second data sequence to a communications network in accordance with Quality of Service (QoS) requirements, the method comprising:
generating the first data sequence by an application;
identifying the application type of the first data sequence by analyzing a first plurality of Open Systems Interconnection (OSI) headers based on a predetermined protocol, wherein the first plurality of OSI headers comprises headers of layers 5 to 7;
obtaining connectivity information about the second data sequence from the content of the first data sequence; and
tagging the first and the second data sequences with a unique ID by analyzing a second plurality of OSI headers, wherein the second plurality of OSI headers comprises headers of layers 3 and 4,
wherein the first and the second data sequences are forwarded to the communications network configured to support Quality of Service (QoS) requirements of the first and the second data sequences.

12. The system of claim 11, wherein the predetermined protocol is a proprietary protocol.

13. The method of claim 11, wherein the predetermined protocol is Session Initiation Protocol (SIP).

14. The system of claim 11, wherein the connectivity information includes types of voice codec.

15. The system of claim 11, wherein the connectivity information includes communications ports.

16. The method of claim 15, wherein the second data sequence passes through the communications ports specified in the content of the first data sequence.

17. The method of claim 12, wherein the unique ID is a VLAN ID defined by a IEEE 802.3 specification.

18. The method of claim 12, wherein the first data sequence carrying the predetermined protocol is tagged with the VLAN ID.

19. The method of claim 12, wherein the second data sequence is tagged with the VLAN ID.

20. The method of claim 12, wherein the VLAN ID is tagged at OSI layer 2 header.
